(19) United States
(12) Patent Application Publication
(10) Pub. No.: US 2018/0041793 A1
(43) Pub. Date: Feb. 8, 2018

(54) HIGH DEFINITION VIDEO TRANSMITTING AND RECEIVING DEVICES AND APPARATUSES AND HIGH DEFINITION VIDEO TRANSMISSION SYSTEM

(71) Applicant: BOE TECHNOLOGY GROUP CO., LTD., Beijing (CN)

(72) Inventor: Yongjie LU, Beijing (CN)

(73) Assignee: BOE TECHNOLOGY GROUP CO., LTD., Beijing (CN)

(21) Appl. No.: 15/525,802

(22) PCT Filed: Jul. 7, 2016
(86) PCT No.: PCT/CN2016/089107

§ 371 Date: May 10, 2017

(30) Foreign Application Priority Data
Jan. 6, 2016 (CN) 201620010451.8

(51) Int. Cl. H04N 21/436; H04N 19/635; H04N 21/41; H04N 21/2747

(52) U.S. Cl. CPC H04N 21/436; H04N 21/2747; H04N 19/635; H04N 21/4104

(57) ABSTRACT

A HD video transmitting device, receiving devices, apparatuses and HD video transmission system are provided in this disclosure, the HD video transmitting device including: a video receiving interface, a video encoding chip connected with the video receiving interface and a video transmitting interface connected with the video encoding chip, wherein the video receiving interface receives primary HD video data and sends the primary HD video data to the video encoding chip; the video encoding chip receives the primary HD video data sent by the video receiving interface, encodes the primary HD video data to obtain HD video data, and sends the HD video data that to the video transmitting interface; and the video transmitting interface receives the HD video data sent by the video encoding chip and sends the HD video data that meet the HDbaseT standard to a video receiving terminal.

### CROSS REFERENCE TO RELATED APPLICATIONS

The present application claims priority of China patent application No. 201620010451.8 filed on Jan. 6, 2016, which is incorporated herein in its entirety by reference.

### FIELD OF THE INVENTION

The present disclosure relates to video transmission technologies, and especially to HD video transmitting and receiving devices and apparatuses as well as an HD video transmission system.

### BACKGROUND

With the development of digitalization, people's demand for HD videos is increasingly common. At present, HD videos are generally transmitted through a High Definition Multimedia Interface (HDMI).

However, the data transmission mode using an HDMI can only achieve a transmission distance of 15 meters. As a result, when the distance between the video transmitting and receiving terminals is larger than 15 meters, HD videos cannot be transmitted by the transmission mode using an HDMI in relevant technologies.

### SUMMARY

In view of this, the present disclosure provides HD video transmitting and receiving devices and apparatuses as well as a video transmission system to achieve long distance transmission of HD video over a distance longer than 15 meters between a video transmitting terminal and a video receiving terminal.

For solving the technical problems above, according to the first aspect of this disclosure, a HD video transmitting device is provided, comprising: a video receiving interface, a video encoding chip connected with the video receiving interface and a video transmitting interface connected with the video encoding chip, wherein the video receiving interface receives primary HD video data and sends the primary HD video data to the video encoding chip; the video encoding chip receives the primary HD video data sent by the video receiving interface, encodes the primary HD video data to obtain HD video data that meet the HDbaseT standard, and sends the HD video data that meet the HDbaseT standard to the video transmitting interface; and the video transmitting interface receives the HD video data that meet the HDbaseT standard sent by the video encoding chip and sends the HD video data that meet the HDbaseT standard to a video receiving terminal.

Electively, wherein the video receiving interface is a High Definition multimedia interface (HDMI) and the primary HD video data are uncompressed HD video data.

Electively, wherein the video encoding chip is a video encoding chip that meets the HDbaseT standard.

Electively, wherein the video transmitting interface sends the HD video data that meet the HDbaseT standard through network cables to the video receiving terminal.

According to the second aspect of this disclosure, a HD video receiving device is provided, comprising: a video receiving interface and a video processing chip connected with the video receiving interface, wherein the video receiving interface receives HD video data that meet the HDbaseT standard sent by a video transmitting terminal and sends the HD video data that meet the HDbaseT standard to the video processing chip; and the video processing chip receives the HD video data that meet the HDbaseT standard sent by the video receiving interface, decodes the HD video data that meet the HDbaseT standard into primary HD video data, and converts the primary HD video data to LDVS signals.

Electively, wherein the video processing chip comprises a decoding chip and a display driving chip connected with the decoding chip, wherein the decoding chip is a video decoding chip that meets the HDbaseT standard that receives the HD video data that meet the HDbaseT standard, decodes the HD video data that meet the HDbaseT standard into primary HD video data and sends the primary HD video data to the display driving chip; and the display driving chip receives the primary HD video data sent by the decoding chip and converts the primary HD video data to LDVS signals.

Electively, wherein the decoding chip sends the primary HD video data through an HDMI to the display driving chip.

According to the third aspect of this disclosure, .a HD video transmitting apparatus is provided, comprising: a host and the HD video transmitting device of the previous first aspect, wherein the HD video transmitting device and the host are connected through an HDMI cable and the host sends primary HD video data to the HD video transmitting device; and the HD video transmitting device receives the primary HD video data, encodes the primary HD video data to obtain HD video data that meet the HDbaseT standard and sends the HD video data that meet the HDbaseT standard to a video receiving terminal.

According to the forth aspect of this disclosure, a HD video display apparatus is provided, comprising: the HD video receiving device of the previous second aspect and a video display unit connected with the HD video receiving device, wherein the HD video receiving device receives the HD video data that meet the HDbaseT standard sent by a video transmitting terminal, decodes the HD video data that meet the HDbaseT standard into primary HD video data, converts the primary HD video data to LDVS signals, and then sends the LDVS signals to the visual display unit; and the video display unit receives the LDVS signals sent by the HD video receiving device and displays HD videos based on the LDVS signals.

Electively, wherein the video display unit is a LCD panel.

According to the fifth aspect of this disclosure, a video transmission system is provided, comprising: the HD video transmitting device of any one of claims 1-4 and the HD video receiving device of any one of claims 5-7, wherein the HD video transmitting device and the HD video receiving device are connected through network cables.

Electively, wherein the network cables are CAT5(Category 5)/5e/6 cables.

The technical solution described above in the present disclosure has the following beneficial effects.

In embodiments of the present disclosure, the received primary HD video data are encoded into HD video data that meet the HDbaseT standard at the video transmitting terminal and sent to the video receiving terminal. Meanwhile, the HD video data that meet the HDbaseT standard are decoded into primary HD video data at the video receiving terminal and displayed. Since the HD video data that meet the HDbaseT standard may support long distance transmission over a distance longer than 15 meters, in this embodiment of the present disclosure, long distance transmission of HD video may be achieved even though the distance between the video transmitting and receiving terminals is larger than 15 meters.

### BRIEF DESCRIPTION OF DRAWINGS

In order to clearly illustrate the technical solution of the embodiments of the invention, the drawings of the embodiments will be briefly described in the following; it is obvious that the described drawings are only related to some embodiments of the invention. As for the skilled in the art, he or she can obtain other figures according to these figures without any inventive labour. The following figures are not intended to be drawn scaling on the actual size, the point is illustrating the main idea of this application.

FIG. 1 is a schematic diagram of an HD video transmitting device in some embodiments of the present disclosure;

FIG. 2 is a schematic diagram of an HD video receiving device in some embodiments of the present disclosure;

FIG. 3 is a schematic diagram of an HD video transmission system in some embodiments of the present disclosure;

FIG. 4 is a specific schematic diagram of another HD video transmission system in some embodiments of the present disclosure;

FIG. 5 is a schematic diagram of an HD video transmitting apparatus in some embodiments of the present disclosure;

FIG. 6 is a specific schematic diagram of another HD video transmitting apparatus in some embodiments of the present disclosure;

FIG. 7 is a schematic diagram of an HD video display apparatus in some embodiments of the present disclosure; and

FIG. 8 is a specific schematic diagram of the HD video display apparatus shown in FIG. 7.

### DETAILED DESCRIPTION OF EMBODIMENTS

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

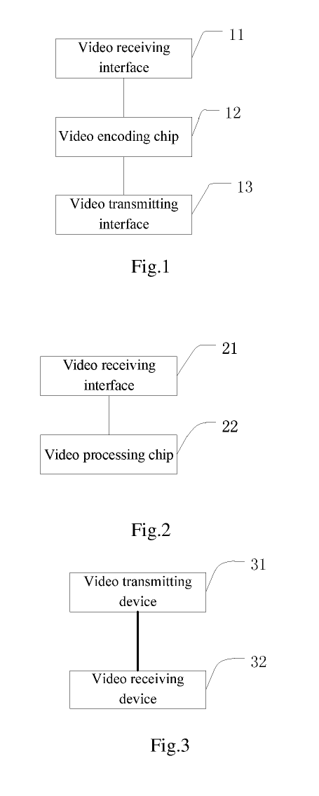

As shown in FIG. 1, an HD video transmitting device in some embodiments of the present disclosure includes:

a video receiving interface 11, a video encoding chip 12 connected with the video receiving interface and a video transmitting interface 13 connected with the video encoding chip 12.

Wherein, the video receiving interface 11 receives primary HD video data and sends them to the video encoding chip 12; the video encoding chip 12 receives the primary HD video data sent by the video receiving interface 11, encodes the received primary HD video data to obtain HD video data that meet the HDbaseT standard, and sends the HD video data that meet the HDbaseT standard to the video transmitting interface 13; the video transmitting interface 13 receives the HD video data that meet the HDbaseT standard sent by the video encoding chip 12 and sends them to a video receiving terminal.

The HDBaseT standard is a video transmission standard formulated by the HDBaseT federation, which was established by some big Japanese and Korean Companies such as LG, Samsung, Sony etc. and the Israeli semiconductor company Valens. In contrast to the HD videos to be transmitted through HDMI, the HD videos that meet the HDBaseT standard enable a transmission distance up to 100 meters and may use CAT5/6 Ethernet cables as transmission media.

In the HD video transmitting device, the video receiving interface 11 may be an HDMI, through which the primary HD video data sent by a video supplying terminal (e.g. a host) are received. At this point, in order to improve video transmission efficiency, the primary HD video data are uncompressed HD video data. Hereafter, the video receiving unit transmits the uncompressed HD video data through an HDMI cable to the video encoding chip.

The video encoding chip is a video encoding chip that meets the HDbaseT standard. In a specific application, a VS100TS chip or any other video encoding chip that satisfies the HDbaseT standard may be used. After having gotten the HD video data that satisfy the HDbaseT standard, the video encoding chip sends the data to the video transmitting interface, i.e. the network interface. And then the HD video data that meet the HDbaseT standard are sent from the network interface through CAT 5/5e/6 or any other type of cables to the video receiving terminal.

Thereby, in this embodiment of the present disclosure, the received primary HD video data is encoded into HD video data that meet the HDbaseT standard at the video transmitting terminal and sent to the video receiving terminal. Since the HD video data that meet the HDbaseT standard may support long distance transmission over a distance longer than 15 meters, in this embodiment of the present disclosure, long distance transmission of HD video may be achieved even though the distance between the video transmitting and receiving terminals is larger than 15 meters.

As shown in FIG. 2, an HD video receiving device in some embodiments of the present disclosure includes a video receiving interface 21 and a video processing chip 22 connected with the video receiving interface 21.

Wherein, the video receiving interface 21 receives the HD video data that meet the HDbaseT standard sent by the video transmitting terminal and sends the data to the video processing chip 22; the video processing chip 22 receives the HD video data that meet the HDbaseT standard sent by the video receiving interface 21, decodes the data into the primary HD video data and converts the primary HD video data into Low-Voltage Differential Signaling (LVDS) signals.

In the video receiving device, the video receiving interface receives the HD video data that meet the HDbaseT standard sent by the video transmitting terminal, and sends the data to the video processing chip. And then the video processing chip decodes the HD video data that meet the HDbaseT standard into the primary HD video data, that is to say, into uncompressed HD video data.

In this embodiment of the present disclosure, the video processing chip 22 includes a decoding chip and a display driving chip connected with the decoding chip. Specifically, the decoding chip receives the HD video data that meet the HDbaseT standard, decodes the data into primary HD video data, and sends the primary HD video data to the display driving chip; the display driving chip receives the primary HD video data sent by the decoding chip and converts them into Low-Voltage Differential Signaling (LVDS) signals.

In a specific application, the decoding chip may be implemented using a chip that meets the HDbaseT standard, for example, the VS100RX chip or the like. The display driving chip may be implemented using a LCD driving chip, for example, the V59 driving chip or the like. Wherein, the decoding chip may send the primary HD video data through an HDMI to the display driving chip.

Thereby, in this embodiment of the present disclosure, the received primary HD video data is encoded into HD video data that meet the HDbaseT standard at the video transmitting terminal and sent to the video receiving terminal. Meanwhile, the HD video data that meet the HDbaseT standard is decoded into primary HD video data at the video receiving terminal and displayed. Since the HD video data that meet the HDbaseT standard may support long distance transmission over a distance longer than 15 meters, in this embodiment of the present disclosure, long distance transmission of HD video may be achieved even though the distance between the video transmitting and receiving terminals is larger than 15 meters.

As shown in FIG. 3, An HD video transmission system in some embodiments of the present disclosure includes an HD video transmitting device 31 and a HD video receiving device 32, which are connected together through network cables.

Wherein, the description of the device embodiment above may be referred to for the configurations and operating principles of the HD video transmitting device 31 and the HD video receiving device 32.

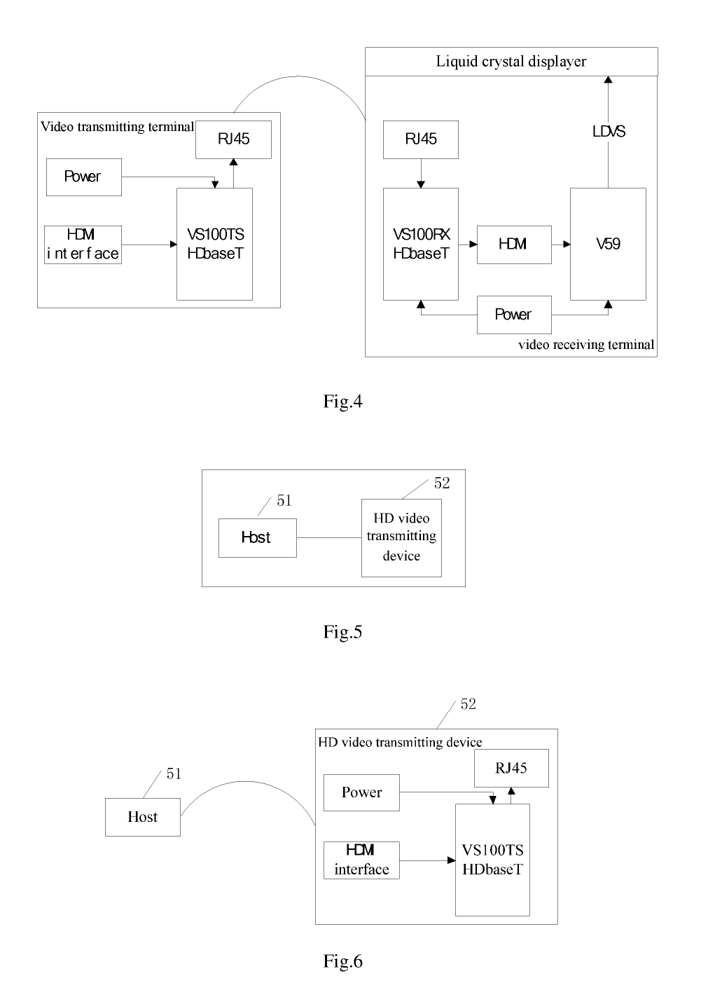

FIG. 4 shows a specific schematic diagram of another HD video transmission system in some embodiments of the present disclosure. In this system, the video encoding chip is implemented using a VS100TS HDbaseT encoder, and the decoding chip is implemented using a VS100RX HDbaseT decoder.

The uncompressed HD video data supplied by a video supplying terminal is received through an HDMI. And then, the uncompressed HD video data is output through a HDMI cable to the VS100TS video encoder. The uncompressed HD video data is encoded and sent to a network interface (RJ 45) by the VS100TS, and then sent to a video receiving terminal through CAT5/5e/6 network cables.

At the video receiving terminal, the uncompressed encoded HD video data transmitted through CAT5/5e/6 cables are received via a network interface (RJ45). The VS100RX chip decodes the uncompressed encoded HD video data to restore them to uncompressed HD videos and sends them to an HDMI. The uncompressed HD video data are converted into LVDS signals by a LCD driving chip such as a V59 and sent to a liquid crystal display to achieve HD video display.

Thereby, in this embodiment of the present disclosure, the received primary HD video data is encoded into HD video data that meet the HDbaseT standard at the video transmitting terminal and sent to the video receiving terminal. Meanwhile, the HD video data that meet the HDbaseT standard is decoded into primary HD video data at the video receiving terminal and displayed. Since the HD video data that meet the HDbaseT standard may support long distance transmission over a distance longer than 15 meters, in this embodiment of the present disclosure, long distance transmission of HD video may be achieved even though the distance between the video transmitting and receiving terminals is larger than 15 meters.

FIG. 5 shows a schematic diagram of an HD video transmitting apparatus in some embodiments of the present disclosure. Wherein, the apparatus includes a host 51 and an HD video transmitting device 52 connected with the host through an HDMI cable.

The host 51 sends the primary HD video data to the HD video transmitting device 52. The HD video transmitting device is the HD video transmitting device described in the embodiment above. The device receives the primary HD video data, encodes them to obtain HD video data that meet the HDbaseT standard and send the HD video data that meet the HDbaseT standard to a video receiving terminal.

FIG. 6 shows a specific schematic diagram of another HD video transmitting apparatus in some embodiments of the present disclosure. In FIG. 6, the HD video transmitting device 52 may be implemented using the devices of the video transmitting terminal described above with reference to FIG. 4.

Thereby, in this embodiment of the present disclosure, the received primary HD video data is encoded into HD video data that meet the HDbaseT standard at the video transmitting terminal and sent to a video receiving terminal. Meanwhile, the HD video data that meet the HDbaseT standard is decoded into primary HD video data at the video receiving terminal and displayed. Since the HD video data that meet the HDbaseT standard may support long distance transmission over a distance longer than 15 meters, in this embodiment of the present disclosure, long distance transmission of HD video may be achieved even though the distance between the video transmitting and receiving terminals is larger than 15 meters.

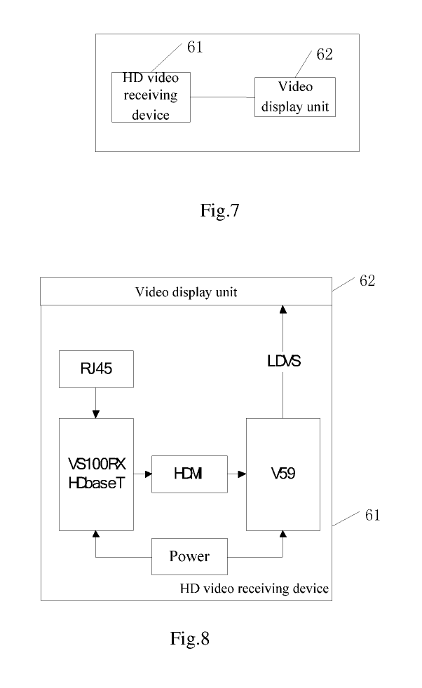

FIG. 7 shows a schematic diagram of an HD video display apparatus in some embodiments of the present disclosure. Wherein, the apparatus includes an HD video receiving device 61 and a video display unit 62 connected with the HD video receiving device.

The HD video receiving device 61 may be the HD video receiving device described in the embodiment above. The HD video receiving device 61 receives the HD video data that meet the HDbaseT standard sent by a video transmitting terminal, decodes the data into primary HD video data, converts the primary HD video data to LDVS signals, and then sends the LVDS signals to the video display unit; the video display unit 62 receives the LDVS signals sent by the HD video receiving device and display HD Videos based on the LDVS signals.

FIG. 8 shows a specific schematic diagram of the HD video receiving apparatus shown in FIG. 7. In FIG. 8, the HD video receiving device 61 may be implemented using the devices of the video receiving terminal described above with reference to FIG. 4.

Thereby, in this embodiment of the present disclosure, the received primary HD video data is encoded into HD video data that meet the HDbaseT standard at a video transmitting terminal and sent to the video receiving terminal. Meanwhile, the HD video data that meet the HDbaseT standard is decoded into primary HD video data at the video receiving terminal and displayed. Since the HD video data that meet the HDbaseT standard may support long distance transmission over a distance longer than 15 meters, in this embodiment of the present disclosure, long distance transmission of HD video may be realized even though the distance between the video transmitting and receiving terminals is larger than 15 meters.

What are described above are related to the illustrative embodiments of the disclosure, it should be noted that, for a skilled in the art, a plurality of amendments and polishing can be made without separated from the principle of the disclosure, and these amendments and polishing should be all as the scope of this disclosure.

1. An HD video transmitting device, comprising: a video receiving interface, a video encoding chip connected with the video receiving interface and a video transmitting interface connected with the video encoding chip, wherein
the video receiving interface receives primary HD video data and sends the primary HD video data to the video encoding chip;
the video encoding chip receives the primary HD video data sent by the video receiving interface, encodes the primary HD video data to obtain HD video data that meet the HDbaseT standard, and sends the HD video data that meet the HDbaseT standard to the video transmitting interface; and
the video transmitting interface receives the HD video data that meet the HDbaseT standard sent by the video encoding chip and sends the HD video data that meet the HDbaseT standard to a video receiving terminal.

2. The device according to claim 1, wherein the video receiving interface is a High Definition multimedia interface (HDMI) and the primary HD video data are uncompressed HD video data.

3. The device according to claim 1, wherein the video encoding chip is a video encoding chip that meets the HDbaseT standard.

4. The device according to claim 1, wherein the video transmitting interface sends the HD video data that meet the HDbaseT standard through network cables to the video receiving terminal.

5. An HD video receiving device, comprising: a video receiving interface and a video processing chip connected with the video receiving interface, wherein
the video receiving interface receives HD video data that meet the HDbaseT standard sent by a video transmitting terminal and sends the HD video data that meet the HDbaseT standard to the video processing chip; and
the video processing chip receives the HD video data that meet the HDbaseT standard sent by the video receiving interface, decodes the HD video data that meet the HDbaseT standard into primary HD video data, and converts the primary HD video data to LDVS signals.

6. The device according to claim 5, wherein the video processing chip comprises a decoding chip and a display driving chip connected with the decoding chip, wherein
the decoding chip is a video decoding chip that meets the HDbaseT standard that receives the HD video data that meet the HDbaseT standard, decodes the HD video data that meet the HDbaseT standard into primary HD video data and sends the primary HD video data to the display driving chip; and
the display driving chip receives the primary HD video data sent by the decoding chip and converts the primary HD video data to LDVS signals.

7. The device according to claim 6, wherein the decoding chip sends the primary HD video data through an HDMI to the display driving chip.

8. An HD video transmitting apparatus, comprising: a host and the HD video transmitting device according to claim 1, wherein
the HD video transmitting device and the host are connected through an HDMI cable and the host sends primary HD video data to the HD video transmitting device; and
the HD video transmitting device receives the primary HD video data, encodes the primary HD video data to obtain HD video data that meet the HDbaseT standard and sends the HD video data that meet the HDbaseT standard to a video receiving terminal.

9. An HD video display apparatus, comprising: the HD video receiving device according to claim 5 and a video display unit connected with the HD video receiving device, wherein
the HD video receiving device receives the HD video data that meet the HDbaseT standard sent by a video transmitting terminal, decodes the HD video data that meet the HDbaseT standard into primary HD video data, converts the primary HD video data to LDVS signals, and then sends the LDVS signals to the visual display unit; and
the video display unit receives the LDVS signals sent by the HD video receiving device and displays HD videos based on the LDVS signals.

10. The HD video display apparatus according to claim 9, wherein the video display unit is a LCD panel.

11. A video transmission system, comprising:
the HD video transmitting device according to claim 1, and
a HD video receiving device, the HD video receiving device comprising: a video receiving interface and a video processing chip connected with the video receiving interface, wherein
the video receiving interface receives HD video data that meet the HDbaseT standard sent by a video transmitting terminal and sends the HD video data that meet the HDbaseT standard to the video processing chip; and
the video processing chip receives the HD video data that meet the HDbaseT standard sent by the video receiving interface, decodes the HD video data that meet the HDbaseT standard into primary HD video data, and converts the primary HD video data to LDVS signals;
wherein the HD video transmitting device and the HD video receiving device are connected through network cables.

12. (canceled)

13. The device according to claim 11, wherein the video processing chip comprises a decoding chip and a display driving chip connected with the decoding chip, wherein
the decoding chip is a video decoding chip that meets the HDbaseT standard that receives the HD video data that meet the HDbaseT standard, decodes the HD video data that meet the HDbaseT standard into primary HD video data and sends the primary HD video data to the display driving chip; and
the display driving chip receives the primary HD video data sent by the decoding chip and converts the primary HD video data to LDVS signals.

14. The device according to claim 13, wherein the decoding chip sends the primary HD video data through an HDMI to the display driving chip.

15. The system according to claim 11, wherein the network cables are CAT5(Category 5)/5e/6 cables.
